(19) United States
(12) Patent Application Publication
(10) Pub. No.: US 2007/0143957 A1
(43) Pub. Date: Jun. 28, 2007

(54) Caster Buffering Device

(75) Inventor: Seung Hang Baek, Incheon (KR)

Correspondence Address: AKERMAN SENTERFITT, P.O. BOX 3188, WEST PALM BEACH, FL, 33402-3188, US

(73) Assignee: Samsong Caster Co., Ltd., Incheon (KR)

(21) Appl. No.: 11/554,181

(22) Filed: Oct. 30, 2006

(30) Foreign Application Priority Data
Dec. 28, 2005 (KR) 20-2005-36638

(51) Int. Cl. B60B 33/00

(52) U.S. Cl. 16/44

(57) ABSTRACT

A caster buffering device is provided and may include a fixing element for coupling with a truck, a supporting element with a supporting piece, vertical pieces and a base piece. The caster buffering device may also include a working element having an end provided with a wheel and the other end connected to the vertical pieces via a connection shaft, a supporting shaft penetrating a through-hole of the working element and the base piece and connected to a coupling nut at an end and buffering elements penetrated by the supporting shaft and having a top surface elastically supported by an elastic piece of the supporting shaft and a lower end elastically supported by the base piece. The buffering element may be formed of at least two or more portions having different elasticities.

### BACKGROUND OF THE INVENTION

1. Field of the Invention

The present invention relates to a caster buffering device, which may apply a buffering force effectively according to a weight of a truck, which secures or doesn't secure an object.

2. Discussion of Related Art

In general, a caster is mounted to each corner portions at a lower part of a truck, which carries an object, for simplifying the carrying of the object for the truck.

A prior art caster, as shown in FIG. 1, includes a fixing element 20 to be coupled with a truck which secures an object, a supporting element 30 extended and folded downward from both side surfaces of the fixing element, a working element 60 having a wheel 61 positioned and coupled in the supporting element via a connection shaft 70, and a base piece 33 extended from the supporting element to be positioned immediately on the working element.

The working element 60 and the base piece 33 are formed with through-holes 34, 62 positioned on the same line, so that a supporting shaft 90 having an elastic supporting piece 91 penetrates the through-holes 34, 62. The elastic supporting shaft 90 has a front end surface surrounded by a buffering element 80 and grounded to the elastic supporting piece 91, and a bottom surface grounded to a top surface of the base piece 33 and spirally coupled with a coupling nut 92 at a lower part of the working element.

The prior art caster 10 as constructed as above is coupled with the truck by means of coupling elements stably while the fixing elements are positioned under the corners of the lower part of the truck. This prior art caster 10 moves truck without any compensation for buffering force even through a difference is generated in the buffering force of the buffering element by the existence of the object to be secured on the truck, wherein the existence of the object causes a difference in the weight of the truck.

In general, the buffering element of the prior art caster is employed in consideration of a weight of the truck securing the object. Therefore, the buffering element absorbs and eliminates vibration or shock transmitted from the ground in the process of moving the truck by a predetermined pressure of the buffering element, thereby realizing the movement of the truck without any transmission of the vibration and shock with respect to the object, since the buffering element is kept in a compressed state by the predetermined pressure when the truck secures the object to carry. However, when the truck is moved without stacking any objects secured thereon, elastic repulsive force of the buffering element cannot absorb or eliminate the vibration and shock but transmits the same to the truck, generating noise and shock a lot in the movement of the truck, since the buffering element has the elastic repulsive force to be buffered when the truck secures the objects thereon.

To the contrary, if the buffering element absorbs and eliminates vibration and shock with respect to the truck not securing any objects thereon, that is, the elastic repulsive force of the buffering force is set for a weight of the truck only, the buffering element may absorb and eliminate the vibration and shock for the truck when moving truck only. In this case, if the truck, however, secures any objects thereon, the buffering element cannot bear a weight of the objects secured on the truck. The buffering element cannot exhibit own repulsive force but carries the truck while being compressed, so that the vibration and shock transmitted from the ground are not effectively buffered by the buffering element but transmitted to the objects via the truck as it is. In this case, the objects such as glasses or mirrors may be damaged in the process of carrying, incurring economical loss.

### SUMMARY OF THE INVENTION

Therefore, the present invention is derived to resolve the above and any other disadvantages of the prior art.

According to the present invention, there is an object to provide a caster buffering device for realizing effectively buffering of a buffering element according to a state of a truck stacking objects thereon, so that vibration or shock and noise caused by the vibration or shock may be prevented in the process of moving the truck and preventing the objects from being damaged by the vibration and shock generated by the movement of the truck, thereby carrying the objects safely.

In order to achieve the above objects, according to the present invention, there is provided a caster buffering device including a fixing element for coupling with a truck, a supporting element positioned at a lower part of the fixing element, and having a supporting piece rotating with respect to a coupling element, vertical pieces extended downward from both sides of the supporting piece, and a base piece provided at a side of each of the vertical pieces, a working element having an end provided with a wheel and the other connected to the vertical pieces via a connection shaft while side surface-grounded to a bottom surface of the base piece, a supporting shaft penetrating a through-hole of the working element and the base piece and connected to a coupling nut at an end, and buffering elements penetrated by the supporting shaft and having a top surface elastically supported by an elastic piece of the supporting shaft and a lower end elastically supported by the base piece, wherein the buffering element is formed of at least two or more different elasticity.

Further, the buffering elements are formed of light and heavy load springs of different elasticity disposed contacting each other.

Furthermore, a washer formed of urethane is provided between the light and heavy load springs.

In addition, the buffering elements are integrally formed with the light and heavy load springs of different elasticity.

### BRIEF DESCRIPTION OF THE DRAWINGS

The objects, features and advantages of the present invention will be more clearly understood from the following detailed description in conjunction with the accompanying drawings, in which

FIG. 1 is a side profile showing a prior art caster;

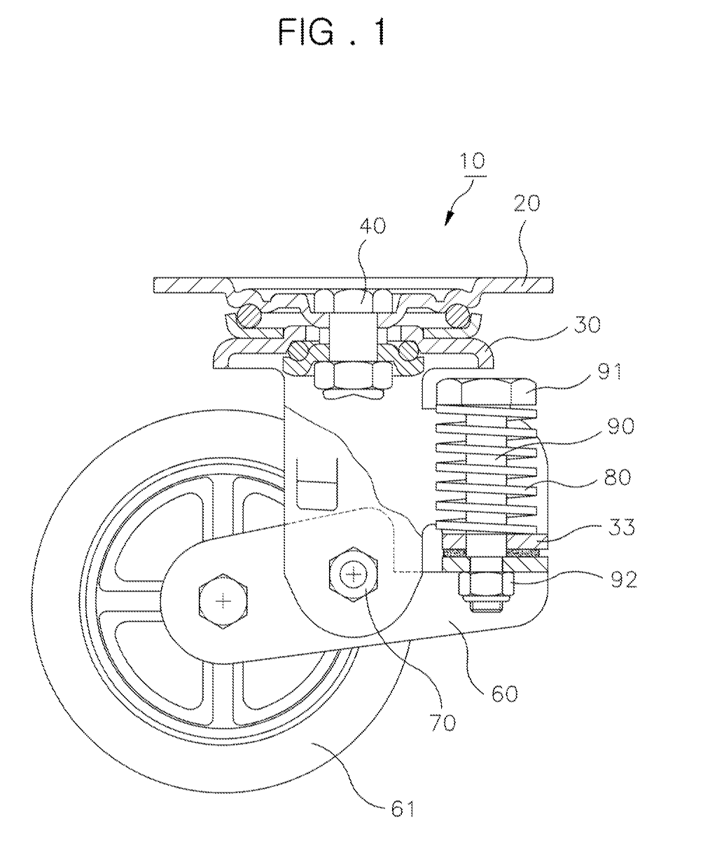

FIG. 2 is a disassembled perspective view showing a caster employing a caster buffering device according to a preferred embodiment of the present invention;

FIG. 3 is a side profile showing a coupling state between a caster and a caster buffering device according to the present invention;

FIG. 4a is a partially expanded cross sectional view showing an operation state of a caster buffering device according to the present invention, wherein a truck secures an object of which weight is below a buffering force of a light load spring;

FIG. 4b is a partially expanded cross sectional view showing an operation state of a caster buffering device according to the present invention, wherein a truck secures an object of which weight is below a buffering force of light and heavy load springs; and

FIG. 5 is a view showing a structure of a caster buffering device according to another preferred embodiment of the present invention.

### DETAILED DESCRIPTION OF THE PREFERRED EMBODIMENTS

Now the preferred embodiments according to the present invention will be described with reference to the accompanying drawings.

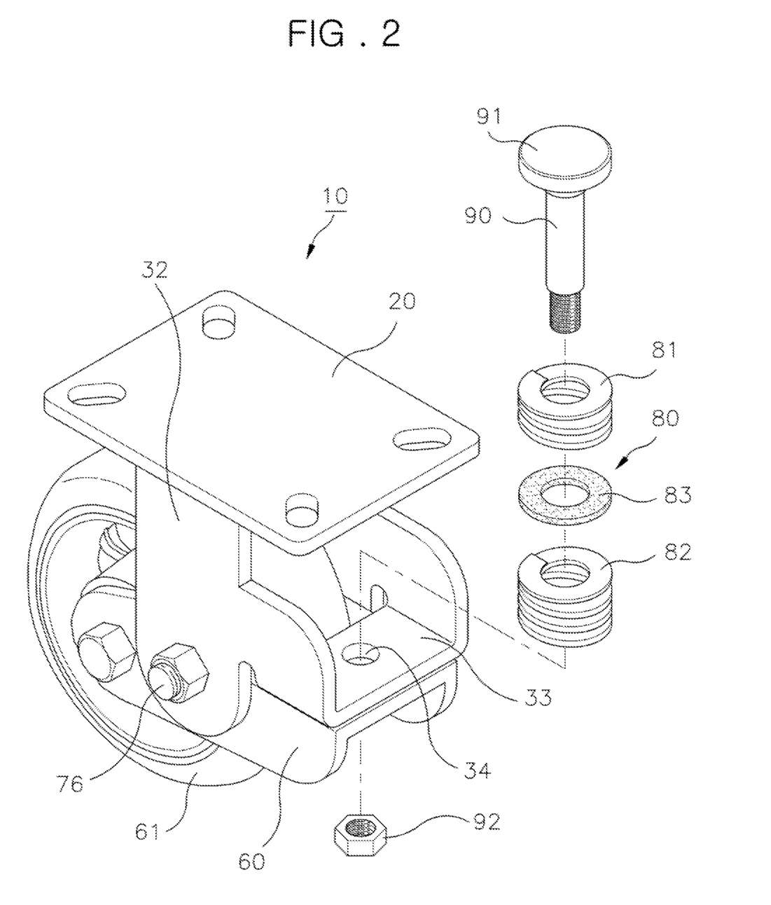

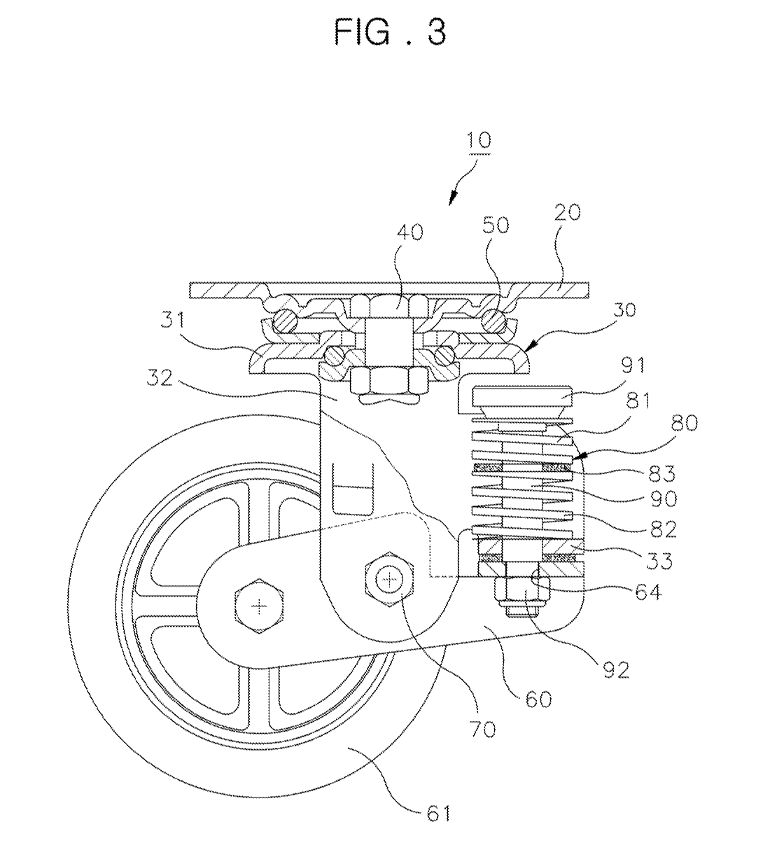

FIG. 2 is a disassembled perspective view showing an entire structure of a caster employing a caster buffering device according to a preferred embodiment of the present invention, and FIG. 3 is a cross-sectional view showing a coupling state between a caster and a caster buffering device according to the present invention, wherein same component parts with the prior art may be indicated by same symbols for the sake of convenience of explanation.

A caster 10 includes a fixing element 20 for the coupling with a truck for stacked objects, and a supporting element 30 coupled at a lower part of the fixing element by a coupling element 40 and rotating with respect to the coupling element 40.

A bearing 50 is provided between the fixing element 20 and the supporting element 30 and helps the supporting element 20 rotate smoothly. The supporting element 30 has a supporting piece 31 surface-contacting with a bottom surface of the fixing element 20 to be coupled with the coupling element 40, vertical pieces 32 extended and folded downward from both sides of the supporting element 30, and a base piece 33 extended from the vertical pieces 32 to secure a buffering element, which will be described hereinafter.

A working element 60 is positioned in lower ends of the vertical pieces 32 of the supporting element 30 and coupled therewith to rotate randomly by a connection shaft 70, wherein the working element 60 has an end provided with a wheel 61 contacting the ground and the other end surface-contacting a bottom surface of the base piece 33.

The buffering element 80 is positioned on the base piece 33 of the supporting element 30. A supporting shaft 90 having an elastic supporting surface 91 penetrates through-holes 34, 62 of the base piece 33 and the working element 60 from a top part of the buffering element, wherein the through-holes 34, 62 of the base piece 33 and the working element 60 are positioned on the same line. The supporting shaft 90 penetrating the working element 60 is coupled with a coupling nut 92 at a lower end protruded below a lower end of the working element 60, so that the buffering element 80 is elastically supported under a predetermined pressure applied by the base piece 33 of the supporting element 30 and the working element 60.

The caster device disclosed herein is an improvement over the prior art in that the buffering element 80 has different elastic pressures.

The buffering element 80 has light and heavy load springs 81, 82 of different elastic pressures, which are prepared individually with a same diameter and stacked together in the vertical direction in use.

A washer 83 formed of urethane is preferably provided between the light and heavy load springs 81, 82 for preventing the generation of noise.

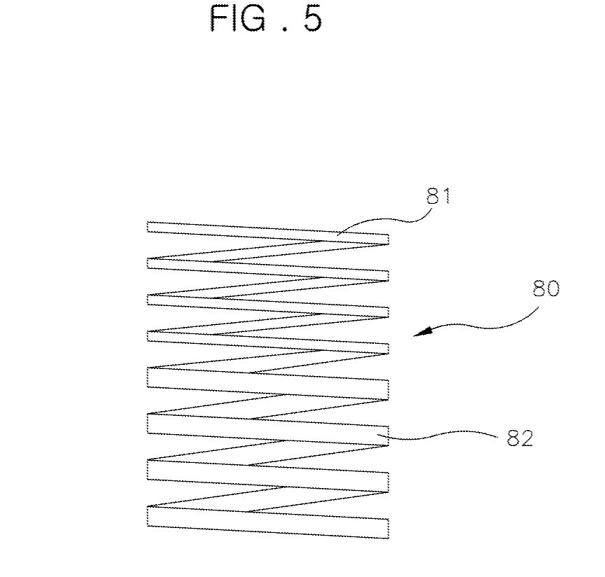

According to another preferred embodiment of the present invention, a buffering element 80 is formed of light and heavy load springs 81, 82, which are formed integrally with difference elastic pressures, as shown in FIG. 5.

In the present caster structured as above, as the fixing element 20 positioned at an uppermost position is coupled and fixed with a truck, the wheel 61 contacting the ground rotates in the movement direction of the truck and the supporting element 30 having the bearing 50 rotates freely with respect to the coupling element 40 to change the advancing direction of the wheel 61 according to the movement direction of the truck, thereby realizing the conversion of direction freely.

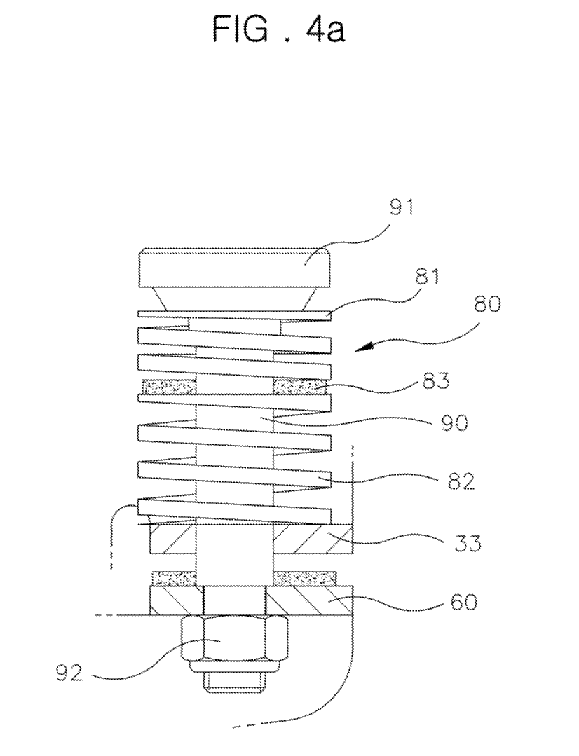

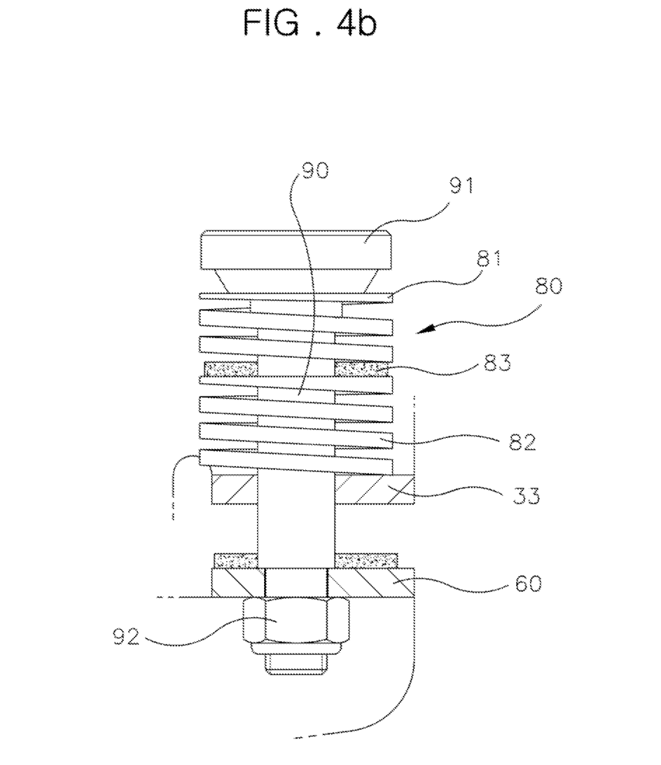

As the caster 10 employing the buffering element 80 formed of the light and heavy load springs 81, 82 of different elastic pressures is mounted to the truck, the wheel 61 rolls according to the movement direction of the truck under circumstances that the light load spring 81 is compressed along as shown in FIG. 4a by a weight of the truck only.

At this time, the heavy load spring 82 of strong elasticity has no change with respect to the weight of the truck itself. If the truck is moved under this circumstances, the vibration and shock generated in the movement of the truck are absorbed and eliminated by the buffering force of the light load spring 81.

If the truck secures objects stacked thereon, the heavy load spring 82 is compressed in addition to the light load spring 81, which is compressed by the weight of the truck itself, as shown in FIG. 4b. The vibration and shocks generated by the movement of the truck are absorbed and eliminated by both of the light and heavy load springs 81, 82 of the buffering element 80 and not transmitted to the objects stacked on the truck. Therefore, the objects may be carried safely and noiselessly.

As described hereinabove, the caster may absorb and eliminate vibration and shock generated in the movement of the truck effectively by employing the buffering element exhibits different buffering force according to the weight of the truck itself and that of the objects secured on the truck, so that the vibration and shock are not transmitted to the objects while the objects are stacked on the truck and the objects may be carried safely without any damage.

Although the foregoing description has been made with reference to the preferred embodiments, it is to be understood that changes and modifications of the present invention may be made by the ordinary skilled in the art without departing from the spirit and scope of the present invention and appended claims.

What is claimed is:

1. A caster buffering device, comprising:
a fixing element for coupling with a truck;
a supporting element positioned at a lower part of the fixing element, and having a supporting piece rotating with respect to a coupling element, vertical pieces extended downward from both sides of the supporting piece, and a base piece provided at a side of each of the vertical pieces;
a working element having an end provided with a wheel and the other end connected to the vertical pieces via a connection shaft while side surface-grounded to a bottom surface of the base piece;
a supporting shaft penetrating a through-hole of the working element and the base piece and connected to a coupling nut at an end; and
buffering elements penetrated by the supporting shaft and having a top surface elastically supported by an elastic piece of the supporting shaft and a lower end elastically supported by the base piece,
wherein the buffering element is formed of at least two or more portions having different elasticities.

2. The caster buffering device as claimed in claim 1, wherein the buffering elements are formed of light and heavy load springs of different elasticity disposed contacting each other.

3. The caster buffering device as claimed in claim 2, wherein a washer formed of urethane is provided between the light and heavy load springs.

4. The caster buffering device as claimed in claim 1, wherein the buffering elements are integrally formed with the light and heavy load springs of different elasticity.
